(19) United States
(12) Patent Application Publication
(10) Pub. No.: US 2007/0286027 A1
(43) Pub. Date: Dec. 13, 2007

(54) Electro-Mechanical Programmer and Electrical Connector Comprising One Such Programmer

(75) Inventor: Romain Guillot, Mionnay (FR)

Correspondence Address: Ralph A. Dowell of DOWELL & DOWELL P.C., 2111 Eisenhower Ave, Suite 406, Alexandria, VA, 22314, US

(73) Assignee: OTIO SAS, Villeurbanne (FR)

(21) Appl. No.: 11/663,959

(22) PCT Filed: Sep. 28, 2005
(86) PCT No.: PCT/FR05/02399

§ 371 Date: May 17, 2007

(30) Foreign Application Priority Data
Sep. 29, 2004 (FR) 0410305

(51) Int. Cl. H01H 43/04

(52) U.S. Cl. 368/10; 368/107

(57) ABSTRACT

The invention relates to an electromechanical programmer which includes a manual adjustment programming dial, a synchronous drive motor for rotating the dial and which is equipped with a terminal pinion. The movement of the terminal pinion is transmitted to the dial enabling the angular position of the dial to be adjusted by rotating the dial in the same direction as that in which the dial is driven by the motor. In order to facilitate dial time setting, the transmission of the movement is done with successive friction gear assemblies which are designed to allow the angular position of the dial to be adjusted by rotating the dial in the opposite direction to that in which the dial is driven by the motor.

The present invention relates to an electromechanical programmer as well as a programmable electrical connector comprising such a programmer.

The invention is applicable in particular to the field of home automation and, more generally, to the automated control of an electrical appliance for the purpose of supplying power to this appliance according to an adjustable timing cycle.

The present-day programmable connectors intended to be electrically interposed between a current source and an appliance are adapted to enable power to be supplied to this appliance by the source only during one or several time intervals in a cyclical manner, generally with a period of one day. For this purpose such a connector is traditionally equipped with an electromechanical programmer, which is more economical than an electronic programming device. This programmer has a programming dial, generally in the form of a wheel, provided with graduations corresponding to temporal sub-divisions of the period of the programming cycle. In the region of each of these sub-divisions the dial is equipped with a segment which can be actuated by the user in such a way as to determine the time range or ranges during which the supply of electrical power is desired. The programmer further comprises a synchronous electrical motor which is supplied by the electrical current source when the connector is connected thereto. This motor drives the programming dial in rotation via a pinion arrangement in such a manner that the dial carries out a complete revolution in one period of the cycle, for example, twenty-four hours.

In order to make the range or ranges selected by the user correspond to the corresponding periods of the day, the user must synchronise the programming dial with the time at which he connects the connector to the current source since from that moment the programmer motor drives the dial in rotation. For this purpose the connector has a marker which is fixed with respect to the dial, enabling the user to have a point of reference for setting the time on the dial. The user can then grip the programming dial and rotate it until the corresponding time graduation marked on the dial is brought opposite the reference marker. The gearing connecting the synchronous motor to the dial actually allows the dial to be decoupled from the output pinion of the motor, but only in one direction of rotation of the dial which is identical to the direction in which this dial is driven by the motor, that is to say in practice in the clockwise direction. In other words, this gearing does not allow the dial to be driven in rotation in an opposite direction, that is to say in an anti-clockwise direction, and the user who forces the programming dial to turn in that direction would risk breaking the transmission gearing and/or the driving motor. Consequently, during the adjustment of the angular position of the dial the user must be careful not to rotate the dial beyond the intended time graduation, otherwise he is obliged to continue the rotation of the dial over almost a complete new turn. Therefore setting the time on the dial proves delicate, long and tiresome for the user.

In another field, namely that of mechanical clock-making, engaging devices in one piece are known for example from DE-A-33 20 242 and DE-A-29 15 526 which are able to transmit a rotary motion between a clock motor element and a timer element whilst permitting the manual adjustment of the timer element in the two possible directions of rotation. For this purpose these devices include resiliently flexible peripheral arms which are provided so as to deform without breaking during the adjustments. However, these devices can only be used when the rotary forces to be transmitted between the motor element and the timer element are of low intensity since the least resistance to the advance of the timer element results in bending of the arms and therefore malfunction of the device.

The object of the present invention is to propose an electromechanical programmer which is reliable, easy to use, economical to manufacture and robust.

In order to achieve this object the invention relates to an electromechanical programmer comprising:
a manually adjustable programming dial,
a synchronous drive motor for rotation of the dial which is equipped with an output pinion or the like, and
mechanical means for transmission of the movement of the output pinion to the dial, adapted to allow the adjustment of the angular position of the dial by a rotary displacement of the dial in a first direction which is identical to the direction in which the dial is driven by the motor,
   characterised in that the transmission means comprise first and second friction gear assemblies adapted to enable the adjustment of the angular position of the dial by a rotary displacement of the dial in a second direction which is contrary to the direction in which the dial is driven by the motor, the first assembly being provided between the output pinion of the motor and the second assembly, and the second assembly being provided between the first assembly and the dial, such that the movement of the output pinion is transmitted to the dial successively via the first and second assemblies, and that during the adjustment of the dial the first assembly is adapted to decouple the output pinion and the second assembly when the dial is displaced in the first direction and the second assembly is adapted to decouple the dial and the first assembly when the dial is displaced in the second direction.

Thus by means of arrangements of the transmission means thereof, the programmer according to the invention makes it possible to adjust the angular position of the programming dial during setting of the time in a manner which is not only easy but also flexible and quick. The use of two friction gear assemblies in series, that is to say one after the other in succession, between the dial and the output pinion of the motor allows adjustment in the two possible directions whilst guaranteeing the efficient transmission of the rotational driving force provided by the motor to the dial, wherein this force has a substantial intensity because of the mechanical detection of the programming ranges within this dial.

According to other characteristics of this programmer, considered in isolation or in any technically possible combination:
the second friction gear assembly comprises a wheel provided with a first toothing in permanent engagement with a part of the first assembly and a second toothing in selective engagement, according to the direction of displacement of the dial during the adjustment thereof, with at least one tooth of an element of the second gear assembly, this element being connected kinematically in rotation to the programming dial,
the said element of the second friction gear assembly is made in one piece with the programming dial,
the or each tooth of the element of the second friction gear assembly is displaceable in a substantially radial direction with respect to the wheel,
the said element of the second friction gear assembly comprises a ring which is coaxial with the wheel, the or each tooth of this element being borne by an arm connected to the ring in a resiliently deformable manner,
the first friction gear assembly comprises a wheel provided with at least one toothing which has a diameter smaller than the diameter of the first toothing of the wheel of the second friction gear assembly,
it further comprises a housing, in the interior of which are disposed the motor and the mechanical transmission means, segments for determination of programming ranges supported by the dial so as to be movable between two end positions, and an actuator disposed on the one hand across the path of the segments supported in one of the end positions and on the other hand outside the path of the segments supported in the other position during driving of the dial by the motor,
the force necessary for the decoupling associated with the second friction gear assembly is greater than the force necessary for the segments to act on the actuator during the driving of the dial by the motor.

The invention also relates to a programmable electrical connector comprising an electrical input plug, at least one electrical output socket and a programmer as defined above, adapted to control the flow and the interruption of the current between the input plug and the or at least one of the output sockets.

The invention will be better understood by reading the following description which is given solely by way of example and with reference to the drawings, in which:

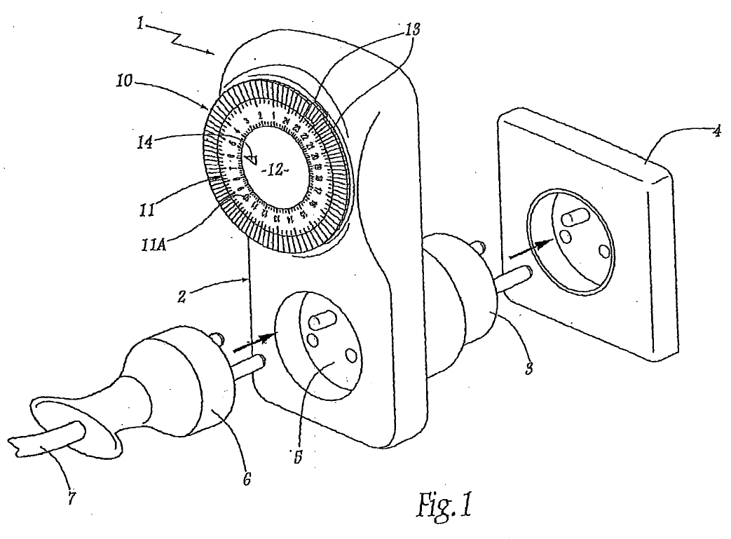

FIG. 1 shows a perspective view of an electrical connector according to the invention;

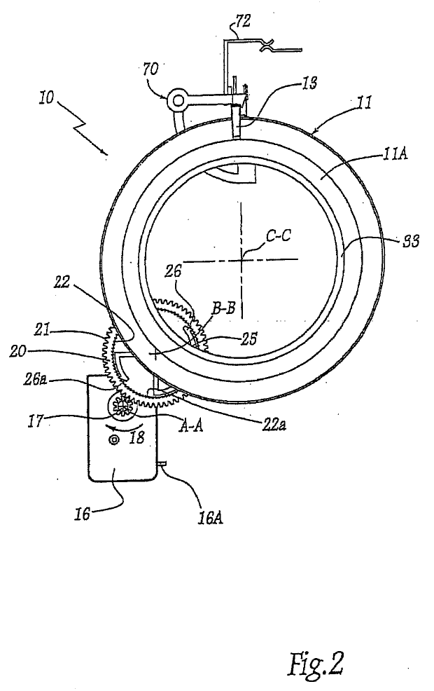

FIG. 2 shows a schematic elevation of a part of a programmer with which the connector of FIG. 1 is equipped;

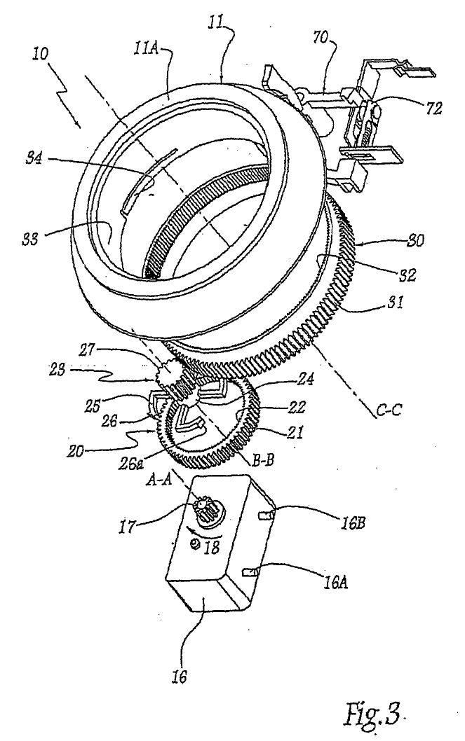

FIG. 3 shows an exploded perspective view of the components of the programmer shown in FIG. 2;

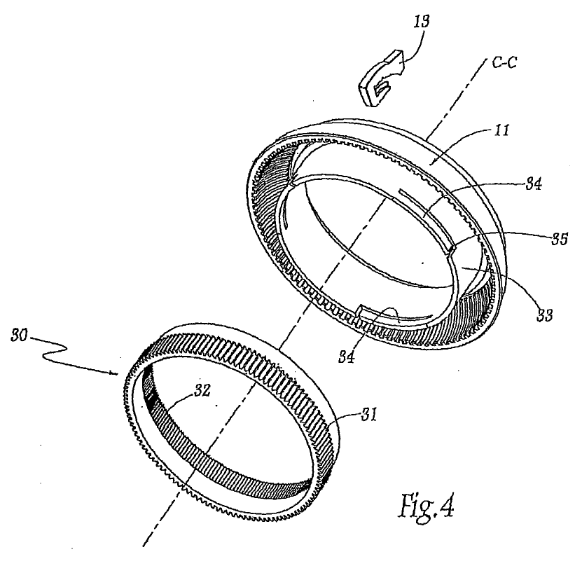

FIG. 4 shows an exploded perspective view, from a different angle of view with respect to that of FIG. 3, of some components of the programmer;

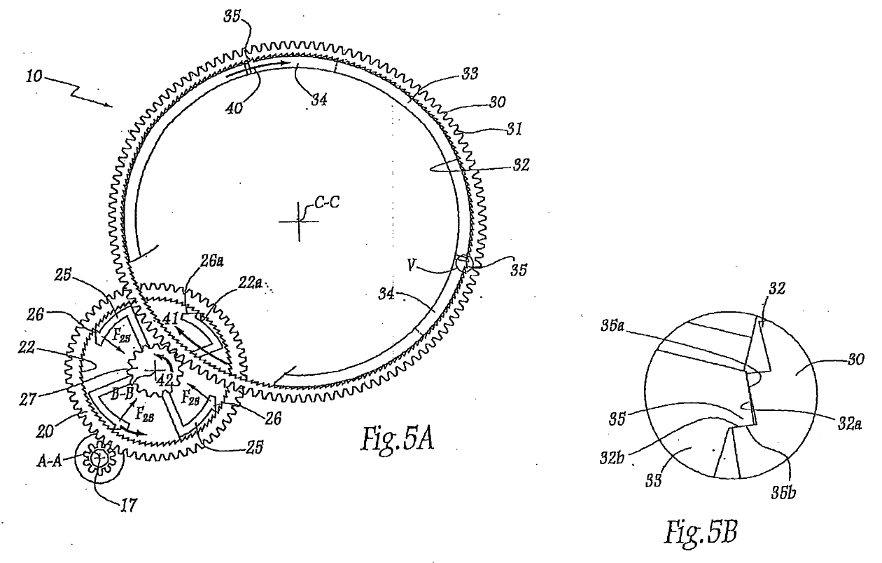

FIGS. 5A, 6 and 7 show schematic views analogous to FIG. 2 of some components of the programmer, illustrating respectively the setting of the time on the dial by rotation of the dial in the clockwise direction, the setting of the time on the dial by rotation of the dial in the contrary direction and the rotation of the dial driven by the motor; and

FIG. 5B shows a schematic view on an enlarged scale of the circled detail V in FIG. 5A.

In FIG. 1 a programmable electrical connector 1 is shown which comprises an electromechanical programmer 2 which is partially visible in FIG. 1, the rest of the programmer being accommodated in an external housing 2 of the connector. The connector 1 further comprises on the one hand an input plug 3 adapted to be introduced into a socket 4, such as a wall socket, and on the other hand an output socket 5 adapted to receive a plug 6 forming the end of an electrical power supply cord 7 of an appliance. The programmer 10 is intended to control the passage of the current between the wall socket 4 and the cord 7 as a function of programming parameters chosen by the user.

For this purpose the part of the programmer 10 which is accessible to the user, that is to say the part of the programmer situated outside the housing 2, comprises a programming dial 11 in the form of a wheel mounted rotatably about a fixed hub which is integral with the housing. The dial 11 supports on its face 11A directed towards the user two series of graduations distributed uniformly along respectively the internal and external peripheries of the dial. These graduations comprise twenty-four principal graduations respectively joined by an increasing number ranging regularly from one to twenty-four, as well as secondary graduations of which there are three between two successive principle graduations. In operation the dial 11 is intended to carry out a complete revolution on itself about the insert 20 in twenty-fours and at a constant speed, such that each principal graduation corresponds to one hour of the day whilst the three secondary graduations between two successive principal graduations correspond to the quarters of an hour between two successive hours.

The programming dial 11 is equipped along its external periphery with ninety-six segments 13, each segment being associated with an angular sector which separates from one another either two successive secondary graduations or a principal graduation and a secondary graduation in succession. Each element 13 is mounted so as to be movable on the dial 11 between a concealed position as shown in the top part of FIG. 1 for some of the segments and a deployed position as shown for the other segments. As is explained in detail below, depending upon whether a segment 13 is in the deployed or concealed position the flow of electrical current between the plug 3 and the socket 5 of the connector 1 is respectively interrupted or ensured. In this way the user can choose one or several time ranges with a minimum duration of a quarter of an hour during which the electric cord 7 is supplied by the wall socket 4. In the illustrated example the cord 7 is supplied with current for one hour, between 10 and 11 p.m.

In order to indicate in time the angular position of the dial 11 during its rotational movement about the hub 12, the programmer 10 is provided with a time marker 14, for example in the form of an arrow in relief supported by the hub. In practice, it is appropriate to synchronise the dial 11 with the current time in such a way that the time graduation on the dial indicated by the marker 14 corresponds effectively to the relevant time of the day as the dial 11 carries out its revolution.

FIGS. 2 to 4 show components of the programmer 10 accommodated inside the housing 2 as well as the dial 11 and one of the segments 13. For the clarity of the drawings, the graduations on the face 11A of the dial are not shown in these figures. The programmer 10 has a synchronous electric motor 16 equipped with two current supply terminals 16A and 16B. When the motor 16 is disposed in the interior of the housing 2 of the connector 1, these terminals 16A and 16B are electrically connected to the terminals of the plug 3 in such a way that when this plug is inserted into the wall socket 4 supplied with electricity the motor 16 is supplied without significant disruption to the electrical current available at the socket 5. The motor 16 is provided with an output pinion 17 which has a longitudinal axis A-A and is disposed so as to turn about its axis in one single direction of rotation indicated by the arrow 18, only at an imposed frequency.

The motor 16 is adapted to generate a driving torque for rotation of the dial 11 about the hub 12 at a pre-imposed speed of rotation which guarantees that the complete revolution of the dial takes place in exactly twenty-four hours. For this purpose the motor is provided internally with a gearbox. The transmission of the rotary movement of the pinion 17 to the dial 11 is provided successively by the following components:
a wheel 20 with an axis of rotation B-B substantially parallel to the axis A-A and having both an external toothing 21, of which the teeth are complementary to the teeth of the output pinion 17 of the motor 16, and an internal toothing 22;
a gearing element 23 of substantially cylindrical shape which is coaxial with the wheel 20 and comprises, on the one hand, a first longitudinal end part 24 provided with four radially projecting branches 25 and each provided at their free end with a tooth 26 shaped so as to co-operate with the internal toothing 22 of the wheel 20 as explained below and, on the other hand, a second longitudinal end part 27 which is toothed along its periphery;
a wheel 30 with an axis of rotation C-C substantially parallel to the axis B-B, having a diameter greater than that of the wheel 20 and comprising both an external toothing 31, of which the teeth are complementary with the teeth of the part 27 of the gearing element 23, and an internal toothing 32; and
a ring 33 which is coaxial with the wheel 30, has an external diameter substantially equal to the internal diameter of the wheel 30 and comprises, in the region of its end part turned towards this wheel, three arms 34 which extend along the periphery of the ring, are distributed uniformly along this periphery and are each provided at their free end with a tooth 35 adapted to co-operate with the internal toothing 32 of the wheel 30 as explained below.

The ring 33 is made from the same material as the programming dial 11, forming an internal skirt for the dial enabling the latter to be mounted rotatably about the hub 12 of which the external diameter is substantially equal to the internal diameter of the ring 33.

The wheels 20 and 30 are non-return friction wheels, that is to say that the respective internal toothings 22 and 32 thereof are shaped so as to engage respectively with some of the teeth 26 of the branches 25 and the teeth 35 of the arms 34 in one single pre-defined direction of rotation whilst in the opposite direction the toothing 22 and each of the teeth 26, and respectively the toothing 32 and each of the teeth 35, have a tendency to slide against one another, by means of the resilient deformation of the branches 25 and respectively the arms 34, and by virtue of the fact that these teeth 26 and 35 have faces 26a (FIG. 2) and 35a (FIG. 5B) inclined in the same direction as the inclined faces 22a (FIG. 2) and 32a (FIG. 5B) of the teeth of the toothings 22 and 32. In other words, in the first direction mentioned above the wheel 20 and the gearing element 23 are rotatably connected to one another, whilst in the opposite direction these elements are mounted with the possibility of rotation with respect to one another, the decoupling between the wheel 20 and the element 23 being obtained by sliding of the faces 26a on the faces 22a due to the driving of one element in rotation with respect to the other with a force of sufficient intensity to deform the branches 25 and cause the teeth to slide against one another. The same applies to the wheel 30 and the ring 33 because the faces 35a and 32a can slide against one another when one element is driven in rotation with respect to the other with a sufficient force.

The wheel 30 and the ring 33 are held together axially by a system (not shown) for clipping in the housing 2, enabling the free rotation of the dial 11 with respect to the wheel 30 in the conditions described below.

The operation of the connector 1, and in particular the operation of the programmer 10 thereof, will be described below with regard to FIGS. 5 to 7.

Hypothetically the user has arranged the segments 13 according to the configuration shown in FIG. 1.

Just before the plug 3 is inserted into the wall socket 4 and thus the supply of power to the motor 16 is ensured, the user must synchronise the programming dial 11 with the current time. As a variant, the user first of all connects the connector 1 to the wall socket 4 and then synchronises the dial 11.

Firstly, it is assumed that in order to carry through this synchronisation the user rotates the dial 11 about the hub 12 in the clockwise direction, as indicated by the arrow 40 in FIG. 5A. In this direction of rotation the teeth 35 of the ring 33 which is rotatably connected to the dial are in engagement with the internal toothing 32 of the wheel by their respective radial faces 35b and 32b in such a way that the wheel 30 is driven in rotation in the clockwise direction, as indicated by an arrow 41. FIG. 5A shows the engagement of the ring 33 and the wheel 30 in a very schematic manner, solely in order to understand the transmission of the forces. The external toothing of this wheel 30, in permanent engagement with the toothed part 27 of the element 23, drives the latter in rotation in the anti-clockwise direction, indicated by an arrow 42. The branches 25 are driven with a corresponding movement, but this movement is not transmitted to the wheel 20 because of the non-return configuration of its internal toothing 22. In fact, the teeth 26 of the branches 25 then slide against the internal toothing 22 taking account of their inclined nature, without driving the wheel 20 in rotation, by radial resilient deformation of the branches 25 indicated by arrows F₂₅. In other words, the gearing element 23 turns with friction inside the wheel 20 whilst the wheel and the output pinion 17 of the motor 16 remain immobile.

Thus the user continues to rotate the dial 11 in the clockwise direction until the graduation of this dial which corresponds to the current time is situated opposite the marker 14.

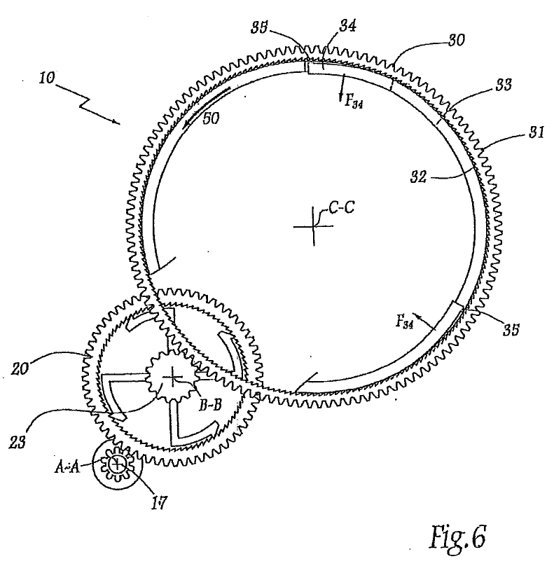

On the assumption that the user has gone past the intended adjustment time, it is possible for him to rotate the dial in the anti-clockwise direction, as shown in FIG. 6. In this case the rotation of the dial 11, indicated by an arrow 50, is not transmitted to the wheel 30 because of the non-return configuration of the internal toothing 32 thereof. In fact, the teeth 35 of the ring 33 then slide against this toothing 32 taking account of their inclined nature, without rotating the wheel 30, by virtue of a radial and centripetal resilient deformation of the arms 34, indicated by arrows F₃₄. In other words, the ring 33 and therefore the dial 11 are then movable in rotation with friction inside the wheel 30. Thus the wheel as well as the gearing element 23, the wheel 20 and the output pinion 17 of the motor 16 remain immobile.

Of course, as a variant, contrary to the adjustment described above, the user can start to adjust the angular position of the dial 11 in the anti-clockwise direction then in the clockwise direction.

Moreover, in so far as the diameter of the wheel 30 is greater than that of the wheel 20, the adjustment of the angular position of the dial 11 in the anti-clockwise direction is more precise than that in the clockwise direction, the sharpness of the internal toothings 22 and 32 of these wheels being similar. In fact, the size of the teeth being substantially identical for these toothings 22 and 32, the number of teeth of the toothing 32 is greater than that of the toothing 22. Of course, as a variant the toothings 22 and 32 can have pitches of differing fineness.

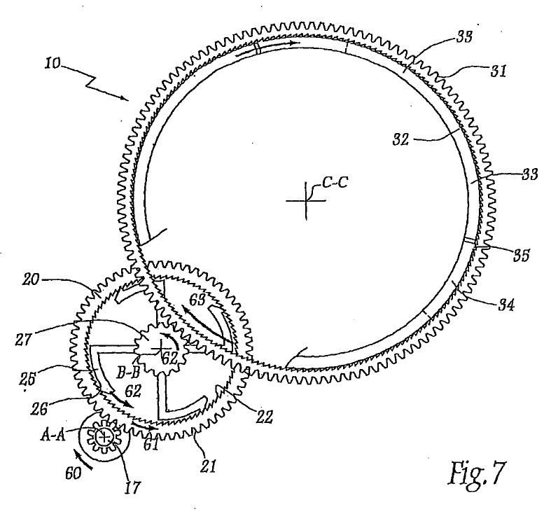

Once the dial 11 is synchronised with the current time and the connector 1 is connected to the wall socket 4, the synchronous motor 16 is supplied with power. As shown in FIG. 7, the rotary movement, indicated by an arrow 60, of the output pinion 17 of the motor drives the wheel 20 in an anti-clockwise direction, as indicated by an arrow 61. The internal toothing 22 of this wheel is in engagement with the teeth 26 of the branches 25 of the gearing element 23 which then turns in an identical direction of rotation, as indicated by the arrows 62. The toothed end part 27 of this element 23 drives the wheel 30 in a contrary direction indicated by an arrow 63. The same then applies to the ring 33 and therefore for the dial 11 by means of the wheel 30. Thus in operation the friction wheels 20 and 30 play their part in rotation of the dial.

It will be understood that, in order that the wheel 30 can transmit its drive to the ring 33, the teeth 35 must be in engagement with the toothing 32 of the ring when in relation to the ring 30 the wheel comes to drive the ring 33 in an anti-clockwise direction, that is to say in a manner analogous to the kinematics described with regard to FIG. 6. In order to do this, the inclination of the bearing faces 35a and 32a of the teeth 35 and of the teeth of the toothing 32, as well as the resilience of the arms 34, are provided so that the force necessary for decoupling the wheel 30 and the ring 33, supplied by the user in FIG. 6, is greater than the driving force transmitted by the wheel 30 in FIG. 7, this force being of course sufficient in order to displace the ring 33 and the dial about the hub 12.

An actuator 70 shown in FIGS. 2 and 3 is situated on the circular path of the segments 13 in the concealed position in such a way that when the dial 11 is driven by the motor 16 the segments in the concealed position act on this actuator which then causes the establishment of an electrical contact by means of a strip contactor 72 intended to control the flow of the current from the plug 3 to the socket 5. After passing a concealed segment or a group of concealed segments, this actuator is returned resiliently to its original position, which breaks the contact at the contactor 72 and consequently interrupts the current flow through the connector 1.

The presence of the actuator 70 must be taken into account in the dimensioning of the non-return means of the wheel 30. The force necessary for decoupling the teeth 35 and the toothing 32 is provided so as to be greater than the force necessary for the displacement of the actuator 70 by the concealed segments 13 and for the actuation of the contactor 72, otherwise the dial 11 would be immobilised by these segments whilst the wheel 30 would turn about the ring 33.

Various developments and variants of the programmer 10 and of the connector 1 described above can also be envisaged. By way of example, rather than providing the ring 33 integrally with the dial 11, this ring can be formed by an element separate from the dial but connected in rotation with the latter. Likewise, the number of arms 34 can be greater or smaller than three as envisaged hitherto.

Moreover, although the illustrated example relates to a dial with ninety-six segments, this time sub-division does not limit the invention and the number of segments used can be greater or smaller, for example it can be equal to one hundred and forty-four or forty-eight. Likewise, the time period of rotation of the dial 11 is not limited to twenty-four hours. Other durations of periods can be envisaged, such as half a day or a week.

Equally by way of a variant the actuator 70 may not be provided so as to be returned resiliently to the original position after passing a concealed segment or a group of concealed segments. In this case the actuator 70 occupies one or the other of two distinct control positions in a stable manner. The programmer 10 is then used in a programmable timer or in a programmable connector/interrupter currently known as a “mono-program programmer”.

Moreover, the arrangement and the nature of the plug 3 and the socket 5 of the connector 1 are merely illustrative and the invention is applicable to connectors in which the plug and socket are for example substantially coaxial with the dial 11 and/or are provided on one or several faces of the housing 2 which are different from those of the dial 11. Moreover, the invention is also applicable to connectors which have a plurality of output sockets, wherein only some of these output sockets or all of these output sockets are controlled by the programmer 10 from the point of view of the circulation of the current through the connector.

The invention has been illustrated during its implementation in an electrical connector of the “programmable plug” type, that is to say a connector forming a unit which can be transported from one wall socket to another. It also applies in the case of a programmable connector integrated into an electrical panel in order to control a fixed appliance such as a swimming pool filtration motor or an external lighting system.

1-9. (canceled)

10. Electromechanical programmer comprising:
a manually adjustable programming dial,
a synchronous drive motor for rotation of the dial which is equipped with an output pinion, and
mechanical transmission means for transmitting of the movement of the output pinion to the dial, wherein the transmission means are adapted to allow the adjustment of the angular position of the dial by a rotary displacement of the dial in a first direction which is identical to the direction in which the dial is driven by the motor, and wherein the transmission means comprise first and second friction gear assemblies adapted to enable the adjustment of the angular position of the dial by a rotary displacement of the dial in a second direction which is contrary to the direction in which the dial is driven by the motor, the first assembly being provided between the output pinion of the motor and the second assembly, and the second assembly being provided between the first assembly and the dial, such that the movement of the output pinion is transmitted to the dial successively via the first and second assemblies, and that during the adjustment of the dial the first assembly is adapted to decouple the output pinion and the second assembly when the dial is displaced in the first direction and the second assembly is adapted to decouple the dial and the first assembly when the dial is displaced in the second direction.

11. Programmer according to claim 10, wherein the second assembly comprises a wheel provided with a first toothing in permanent engagement with a part of the first assembly and a second toothing in selective engagement, according to the direction of displacement of the dial during the adjustment thereof, with at least one tooth of an element of the second gear assembly, this element being connected kinematically in rotation to the programming dial.

12. Programmer according to claim 11, wherein said element of the second assembly is made in one piece with the programming dial.

13. Programmer according to claim 11, wherein the or each tooth of said element of the second assembly is displaceable in a substantially radial direction with respect to the wheel.

14. Programmer according to claim 11, wherein said element of the second assembly comprises a ring which is coaxial with the wheel, the or each tooth of said element being borne by an arm connected to the ring in a resiliently deformable manner.

15. Programmer according to claims 11, wherein the first assembly comprises a wheel provided with at least one toothing which has a diameter smaller than the diameter of the first toothing of the wheel of the second assembly.

16. Programmer according to claim 10, wherein further comprising a housing, in the interior of which are disposed the motor, the transmission means, segments for determination of programming ranges supported by the dial so as to be movable between two end positions, and an actuator disposed on the one hand across the path of the segments supported in one of the end positions and on the other hand outside the path of the segments supported in the other position during driving of the dial by the motor.

17. Programmer according to claim 16, wherein the force necessary for the decoupling associated with the second assembly is greater than the force necessary for the segments to act on the actuator during the driving of the dial by the motor.

18. Programmable electrical connector comprising an electrical input plug, at least one electrical output socket and an electromechanical programmer according to claim 10, adapted to control the flow and the interruption of the current between the input plug and the or at least one of the output sockets.

19. Programmable electrical connector comprising an electrical input plug, at least one electrical output socket and an electromechanical programmer according to claim 11, adapted to control the flow and the interruption of the current between the input plug and the or at least one of the output sockets.
